(19) United States
(12) Patent Application Publication
(10) Pub. No.: US 2026/0093010 A1
(43) Pub. Date: Apr. 2, 2026

(54) METHOD FOR DETECTING AN ENVIRONMENT-INDUCED SENSOR IMPAIRMENT AND VEHICLE SENSOR SYSTEM

(71) Applicant: Robert Bosch GmbH, Stuttgart (DE)

(72) Inventors: Albert Kasdorf, Ebernhahn (DE); Arbenit Kryeziu, Stuttgart (DE); Jochen Vogt, Rosenberg (DE); Johannes Windschuh, Heilbronn (DE)

(21) Appl. No.: 19/297,543

(22) Filed: Aug. 12, 2025

(30) Foreign Application Priority Data
Sep. 30, 2024 (DE) 10 2024 209 526.5

(51) Int. Cl. G01S 7/40; G01S 13/86; G01S 13/931

(52) U.S. Cl. CPC G01S 7/40; G01S 13/867; G01S 13/931

(57) ABSTRACT

A method for detecting an environment-induced sensor impairment of a radar sensor of a vehicle. The method includes: providing an environment sensor system comprising the radar sensor and at least one further environment sensor, for detecting at least one environment object in a vehicle environment of the vehicle; detecting an environment region of the vehicle environment which at least partially comprises the environment object and lies in a field of view of the radar sensor and a field of view of the at least further environment sensor, using the radar sensor and at least the further environment sensor; creating an environment object model of the environment object according to fused sensor data formed by the detection of the environment region; ascertaining a contribution of the radar sensor to the fused sensor data; and calculating an impairment state of the radar sensor according to the contribution.

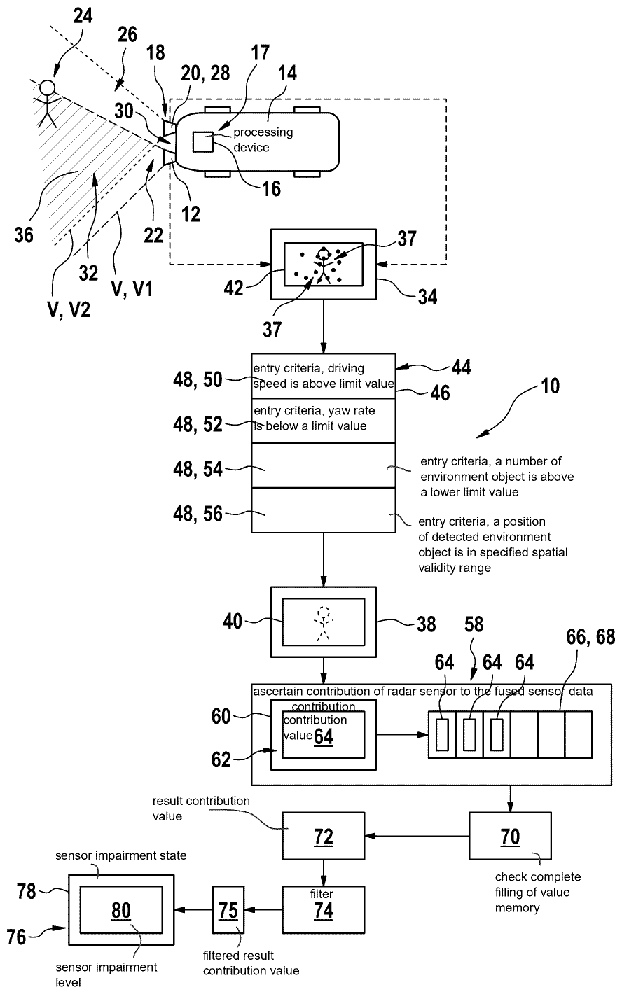

### CROSS REFERENCE

The present application claims the benefit under 35 U.S.C. § 119 of German Patent Application No. DE 10 2024 209 526.5 filed on Sep. 30, 2024, which is expressly incorporated herein by reference in its entirety.

### FIELD

The present invention relates to a method for detecting an environment-induced sensor impairment of a radar sensor. The present invention also relates to a vehicle sensor system.

### BACKGROUND INFORMATION

Europe Patent Application No. EP 4 407 339 A1 describes a detection of an environment-induced sensor impairment in a radar sensor, in which raw sensor data of the radar sensor and object detection results obtained therefrom are evaluated and an impairment state of the radar sensor is calculated exclusively according to the raw sensor data and the object detection results.

### SUMMARY

According to an example embodiment of the present invention, a method for detecting an environment-induced sensor impairment of a radar sensor of a vehicle, includes the following steps: providing an environment sensor system comprising the radar sensor and at least one further environment sensor, for detecting at least one environment object in a vehicle environment of the vehicle; detecting an environment region of the vehicle environment which at least partially comprises the environment object and lies in a field of view of the radar sensor and a field of view of the at least further environment sensor, by means of the radar sensor and at least the further environment sensor; creating an environment object model of the environment object according to fused sensor data formed by the detection of the environment region by the radar sensor and at least the further environment sensor; ascertaining a contribution of the radar sensor to the fused sensor data; and calculating a sensor impairment state of the radar sensor according to the contribution.

As a result, the sensor impairment of the radar sensor can be detected more reliably and accurately.

The further environment sensor can be a radar sensor, a lidar sensor, an ultrasonic sensor or a camera.

The radar sensor and/or the further environment sensor can be arranged in a front region, corner region, side region, roof region or rear region of the vehicle. The radar sensor and/or the further environment sensor can detect the vehicle environment in front of, next to and/or behind the vehicle.

According to an example embodiment of the present invention, the environment sensor system is located in the vehicle.

The environment object can be a building, a facility, a device, an object, another vehicle, a living being or a plant.

The environment-induced sensor impairment can be a restriction of visibility, in particular due to precipitation, for example rain and/or an obscuration, in particular contamination, wetting and/or a coating with unwanted material on a sensor surface of the radar sensor. The material can be water, ice, snow, dirt, dust, sand and/or organic material. The environment-induced sensor impairment can only be caused by environmental influences on the radar sensor.

The sensor impairment can be a reduction in the detection performance of the radar sensor in relation to the detection of environment objects in the vehicle environment. The reduction in detection performance can comprise a reduction in resolution, range, accuracy, field of view and/or sensitivity of the radar sensor.

The environment region can be spanned by an elevation angle, an azimuth angle range and a distance.

The sensor data of the radar sensor can be processed from measurement data of the radar sensor. The measurement data of the radar sensor can form the sensor data of the radar sensor. The sensor data of the further environment sensor can be processed from measurement data of the further environment sensor. The measurement data of the further environment sensor can form the sensor data of the further environment sensor.

The environment object model can specify at least one parameter relating to the environment object. The parameter can be a position, a size, an elevation angle, an azimuth angle, a distance, a speed, a direction of movement, a planned movement trajectory or a classification of the environment object.

According to an example embodiment of the present invention, creating the environment object model according to the sensor data can comprise a selection of the environment object underlying the environment object model from a plurality of environment objects that at least partially lie in the environment region and/or a selection of an environment object model from a plurality of environment object models that are in each case calculated for environment objects that at least partially lie in the environment region. The selection can be carried out according to the distance of the environment object from the environment sensor system. The selected environment object can be the one closest to the environment sensor system in the environment region.

The environment region can lie in an overlap region between the field of view of the radar sensor and the field of view of the further environment sensor. The environment region can span the entire overlap region or a section of the overlap region.

According to an example embodiment of the present invention, the contribution of the radar sensor to the fused sensor data can be measured on the basis of a redundancy of information that can be confirmed on the basis of the detection by the at least one further environment sensor, a consistency of information between the radar sensor and the at least one further environment sensor, a reliability of the information of the radar sensor and/or an accuracy of the information of the radar sensor.

In a preferred embodiment of the present invention, it is advantageous if ascertaining the contribution comprises ascertaining at least one contribution value of the contribution. The contribution value can be binary or multi-valued. If the contribution value is binary, a contribution of the radar sensor to the fused sensor data can be detected by 1 and no contribution or a contribution below a threshold can be detected by 0. If the contribution value is multi-valued, the contribution can be graded according to the contribution of the radar sensor to the fused sensor data. 0 can represent no contribution and 1 can represent a maximum possible contribution and the values in between are calculated according to a contribution share.

In a preferred embodiment of the present invention, it is advantageous if ascertaining the contribution comprises storing, i.e., saving, the ascertained contribution value in a value memory. The value memory can be a list or an array. Storing the contribution value in the value memory can involve appending the currently ascertained contribution value to the list or an entry into the array.

According to an example embodiment of the present invention, ascertaining the contribution of the radar sensor to the fused sensor data can be dependent on at least one entry condition.

In a special configuration of the present invention, it is advantageous if storing the contribution value in the value memory is dependent on at least one entry condition. As a result, pre-filtering can be implemented prior to storage.

In a preferred example embodiment of the present invention, it is advantageous if the entry condition comprises at least one of the following entry criteria: a driving speed of the vehicle is above a limit value, a yaw rate of the vehicle is below a limit value, a number of environment objects in the environment region is above a lower limit value and below an upper limit value, a position of the detected environment object is in a specified spatial validity range of the environment region. The mentioned limit values are specified. The mentioned limit values can change during vehicle operation, for example according to the environmental and/or driving conditions of the vehicle.

The entry condition can comprise at least two of the specified entry criteria. The spatial validity range can be specified by a minimum and maximum longitudinal and/or lateral distance between the environment sensor system and the environment object. The longitudinal distance can be along a longitudinal axis and the lateral distance can be along a transverse axis of the vehicle. The yaw rate can indicate a rotational movement of the vehicle about a vertical axis of the vehicle.

The entry condition can be fulfilled if one, a plurality of or all of the entry criteria are fulfilled.

In a special configuration of the present invention, it is advantageous if the method for detecting and thereby storing the ascertained contribution value by appending it to the value memory is executed repeatedly and the sensor impairment state is calculated according to the contribution values in the value memory. The repeated execution can be timed by measurement cycles of the radar sensor. The method can be executed at most once per measurement cycle of the radar sensor. The method can be executed in each case in two immediately consecutive measuring cycles.

The value memory can be a circular buffer. The ascertained contribution value can be stored in a filled value memory by removing the oldest stored ascertained contribution value.

In an advantageous example embodiment of the present invention, at least one result contribution value is calculated from the contribution values in the value memory. The result contribution value can be calculated as the mean of the contribution values in the value memory. The mean can be an arithmetic, geometric or quadratic mean. The mean can be an average value, for example calculated on the basis of the following relationship

$$E = \frac{A}{S}$$

using the result contribution value E, the number A of 1 in the value memory for binary contribution value and the number of possible entries (size) S of the value memory.

In a preferred example embodiment of the present invention, it is advantageous if a filter is applied to the result contribution value and the sensor impairment state is calculated according to the filtered result contribution value. The filter can be an infinite impulse response (IIR) filter.

Alternatively or additionally, the filter can be applied to the contribution value and/or a sequence of contribution values when the method is repeatedly executed.

In a preferred example embodiment of the present invention, it is advantageous if the sensor impairment state comprises a sensor impairment level and calculating the sensor impairment state comprises calculating the sensor impairment level of the radar sensor. The sensor impairment level can be binary or multi-valued. If the sensor impairment level is binary, 1 can represent impairment and 0 can represent no impairment.

The lower, less frequent, and/or more irregular the contribution of the radar sensor to the fused sensor data is, the more likely it is that the radar sensor is impaired, and accordingly, the more likely it is that a binary sensor impairment level will be 1, and the more likely it is that a multi-valued sensor impairment level will be higher.

The sensor impairment level can quantitatively describe the sensor impairment, in particular the reduction in detection performance. For example, a sensor impairment level with a value of 1 out of a value range from 0 to 1 can indicate a complete impairment of the radar sensor, in particular a lack of detection performance of the radar sensor.

According to the level of sensor impairment detected, measures can be taken such as issuing a warning message, signaling to a vehicle user, assessing the reliability in the creation of the environment object model and/or cleaning the radar sensor to remove and/or reduce the impairment.

According to the present invention, a vehicle sensor system is also provided. The processing device can be assigned to a control unit of the vehicle. The processing device can be arranged in the vehicle. The processing device can comprise at least one processor for performing at least one of the steps or sub-steps of the detection method of the present invention.

Further advantages and advantageous configurations of the present invention can be found in the description of the figures and in the FIGURES.

### BRIEF DESCRIPTION OF THE DRAWINGS

The FIGURE shows a detection method and an environment sensor system according to an example embodiment of the present invention.

### DETAILED DESCRIPTION OF EXAMPLE EMBODIMENTS

The present invention is described in detail below with reference to the FIGURE.

The FIGURE shows a detection method and an environment sensor system, in each case in a specific embodiment of the invention. The method 10 for detecting an environment-induced sensor impairment of a radar sensor 12 of a vehicle 14 can be carried out by a processing device 16 of a vehicle sensor system 17 in the vehicle 14 and initially comprises providing 18 an environment sensor system 22 comprising the radar sensor 12 and at least one further environment sensor 20, for detecting at least one environment object 24 in a vehicle environment 26 of the vehicle 14. The radar sensor 12 and the further environment sensor 20, for example a camera 28, can be arranged on a vehicle front 30 of the vehicle 14 and detect a front environment region 32 of the vehicle 14. The fields of view V of the radar sensor 12 and the further environment sensor 20 overlap at least partially.

Furthermore, an environment region 32 of the vehicle environment 26 which at least partially comprises the environment object 24 and lies in a field of view V1 of the radar sensor 12 and a field of view V2 of the at least further environment sensor 20 is detected 34 by the radar sensor 12 and at least the further environment sensor 20. The environment object 24 is therefore at least partially located in an overlap region 36 of the field of view V1 of the radar sensor 12 and the field of view V2 of the further environment sensor 20. The environment region 32 can span the entire overlap region 36 or a section of the overlap region 36. The environment object 24 is detected 34 via sensor data 37 provided by the radar sensor 12 and the further environment sensor 20.

Furthermore, an environment object model 40 of the environment object 24 is created 38 according to the fused sensor data 42 formed by the detection of the environment region 32, i.e. the sensor data, by the radar sensor 12 and at least the further environment sensor 20. The environment object model 40 can be calculated by the sensor fusion and the fused sensor data 42 formed therefrom. The environment object 24 for which the environment object model 40 is created can be selected from a plurality of environment objects 24 that at least partially lie in the environment region 32. For example, the selected environment object 24 can be the environment object 24 closest to the vehicle 14. An environment object model 40 can also be created for each environment object 24 of the plurality of environment objects 24 and the environment object model 40 of a selected environment object 24 can be used subsequently, while the other environment object models 40 are excluded from subsequent use.

The selection or creation of the environment object model 40 can be preceded by a check 44 of an entry condition 46. The entry condition 46 can comprise a plurality of entry criteria 48. The entry criteria 48 can be the following: a driving speed 50 of the vehicle 14 is above a limit value, a yaw rate 52 of the vehicle 14 is below a limit value, a number 54 of the environment objects 24 in the environment region 32 is above a lower limit value and below an upper limit value, a position 56 of the detected environment object 24 is in a specified spatial validity range of the environment region 32. The spatial validity range can be specified by a minimum and maximum longitudinal and/or lateral distance between the environment sensor system 22 and the environment object 24.

If the checked entry condition 46 is fulfilled, for example, if some or all of the entry criteria 48 are fulfilled, the previously described selection of the environment object model 40 calculated according to the fused sensor data 42 or of the environment object 24 for which the environment object model 40 is calculated according to the fused sensor data 42 is performed.

Subsequently, a contribution 60 of the radar sensor 12 to the fused sensor data 42 is ascertained 58. Ascertaining 58 the contribution 60 can comprise ascertaining 62 at least one contribution value 64 of the contribution 60. For example, the contribution value 64 can be binary. Then, a contribution 60 of the radar sensor 12 to the fused sensor data 42 is indicated by 1, and no contribution 60 or a contribution 60 below a limit value is indicated by 0. Ascertaining 58 the contribution 60 comprises storing the ascertained contribution value 64, here 1 or 0, in a value memory 66, which is, for example, an array 68 having a specified size. In particular, the contribution value 64 is inserted into the array 68. The value memory 66 can be a circular buffer. The ascertained contribution value 64 can be stored in a filled value memory 66 by removing the oldest stored ascertained contribution value 64.

The described method 10 for detecting and thereby storing the ascertained contribution value 64 by appending it to the value memory 66 is preferably executed repeatedly and, for example, in a manner timed by the measurement cycles of the radar sensor. Thus, the value memory 66 is filled with the contribution values 64 as the number of repetitions of the method increases.

Furthermore, the complete filling of the value memory 66 is checked 70 on the basis of the known number of possible entries in the value memory 66 and the detected number of measurement cycles for which the method was executed in each case. If the value memory 66 is full, a result contribution value 72 is calculated from the contribution values 64 in the value memory 66. The result contribution value 72 can be calculated as the average value of the contribution values 64 in the value memory 66.

Subsequently, a filter 74, for example an infinite impulse response filter 74, is applied to the result contribution value 72 and thus a filtered result contribution value 75 is calculated.

Finally, a sensor impairment state 78 of the radar sensor 12 is calculated 76 according to the contribution 60, in particular according to the filtered result contribution value 75. Calculating 76 the sensor impairment state 78 can comprise calculating 76 a sensor impairment level 80 of the radar sensor 12. For example, the sensor impairment level 80 is multi-valued and increases the smaller the filtered result contribution value 75 is.

What is claimed is:

1. A method for detecting an environment-induced sensor impairment of a radar sensor of a vehicle, comprising the following steps:
providing an environment sensor system including the radar sensor and at least one further environment sensor, for detecting at least one environment object in a vehicle environment of the vehicle;
detecting an environment region of the vehicle environment which at least partially includes the environment object and lies in a field of view of the radar sensor and a field of view of the at least one further environment sensor, using the radar sensor and at least the further environment sensor;
creating an environment object model of the environment object according to fused sensor data formed by the detection of the environment region by the radar sensor and at least the further environment sensor;
ascertaining a contribution of the radar sensor to the fused sensor data; and
calculating a sensor impairment state of the radar sensor according to the contribution.

2. The method for detecting according to claim 1, wherein the ascertaining of the contribution includes ascertaining at least one contribution value of the contribution.

3. The method for detecting according to claim 2, wherein the ascertaining of the contribution includes storing the ascertained contribution value in a value memory.

4. The method for detecting according to claim 3, wherein the storing of the contribution value in the value memory is dependent on at least one entry condition.

5. The method for detecting according to claim 4, wherein the entry condition includes at least one of the following entry criteria:
a driving speed of the vehicle is above a limit value,
a yaw rate of the vehicle is below a limit value,
a number of environment objects in the environment region is above a lower limit value and below an upper limit value,
a position of the detected environment object s in a specified spatial validity range of the environment region.

6. The method for detecting according to claim 3, wherein the method for detecting and storing the ascertained contribution value by appending it to the value memory is executed repeatedly and the sensor impairment state is calculated according to the contribution values in the value memory.

7. The method for detecting according to claim 6, wherein at least one result contribution value is calculated from the contribution values in the value memory.

8. The method for detecting according to claim 7, wherein a filter is applied to the result contribution value and the sensor impairment state is calculated according to the filtered result contribution value.

9. The method for detecting according to claim 1, wherein the sensor impairment state includes a sensor impairment level and the calculating of the sensor impairment state includes calculating the sensor impairment level of the radar sensor.

10. A vehicle sensor system for a vehicle, comprising:
an environment sensor system including a radar sensor and at least one further environment sensor, in each case configured to detect at least one environment object in a vehicle environment of the vehicle; and
a processing device configured to create an environment object model of the environment object according to fused sensor data formed by the detection by the radar sensor and at least the further environment sensor, and to detect an environment-induced sensor impairment of the radar sensor, by:
detecting an environment region of the vehicle environment which at least partially includes the environment object and lies in a field of view of the radar sensor and a field of view of the at least one further environment sensor, using the radar sensor and at least the further environment sensor,
creating the environment object model of the environment object according to the fused sensor data formed by the detection of the environment region by the radar sensor and at least the further environment sensor,
ascertain a contribution of the radar sensor to the fused sensor data, and
calculate a sensor impairment state of the radar sensor according to the contribution.
